(19) United States
(12) Patent Application Publication
(10) Pub. No.: US 2003/0035515 A1
(43) Pub. Date: Feb. 20, 2003

(54) Method and device for transmitting messages in an intelligent network

(76) Inventors: Can Davutoglu, Wien (DE); Viola Kriete, Muenchen (DE)

Correspondence Address: Bell, Boyd & Lloyd LLC, P.O. Box 1135, Chicago, IL, 60690, US

(21) Appl. No.: 10/219,038

(22) Filed: Aug. 14, 2002

(30) Foreign Application Priority Data
Aug. 14, 2001 (DE) 101 39 866.2

(51) Int. Cl. H04M 11/00

(52) U.S. Cl. 379/88.13

(57) ABSTRACT

A method and device are provided for transmitting messages in an intelligent network in which a subscriber is assigned a multiplicity of different communications terminals. When a message for the subscriber is received, at least one communications terminal is selected for the reception of the message as a function of an accessibility profile of the subscriber and/or of the type of message, and the message is passed on to the at least one selected communications terminal.

### BACKGROUND OF THE INVENTION

Nowadays, subscribers of a telecommunications network generally have a number of communications terminals; for example, a fixed line telephone, a mobile telephone, a telefax device and an e-mail address and/or e-mail box. Not only physical units, such as the abovementioned telephones, but also units such as an e-mail address and/or e-mail box which are not present physically are, therefore, to be understood as telecommunications terminals here. In order to be able to transmit a message to the subscriber, one of his/her communications terminals is selected, and the message is transmitted to the selected device.

However, this can result in problems as a result of the subscriber not being accessible at all times and at all places. For example, he/she may only be accessible via his/her mobile telephone at certain times. An important telefax message therefore may not reach him/her immediately. It is therefore desirable to “unify” or even better combine the communications media and terminals for optimum and efficient communication.

This approach is already known as unified messaging. Here, various forms of messages such as voice messages, text messages or image messages are integrated into a system and made available to a subscriber for calling. In such a system, the subscriber is generally provided with a type of universal mail box in which all the messages addressed to him/her are stored, irrespective of the format of the message. The subscriber can call these messages via a suitable software program using a computer. However, in this case, it is not ensured that the subscriber will receive a message immediately. In order to be able to access his/her mailbox, the subscriber generally requires a computer with Internet access, which is not available to him/her everywhere.

There is now the possibility of the reception of a new message in his/her mailbox being communicated to the subscriber on his/her mobile telephone via an SMS (short message service) message. However, here too, the subscriber requires access to his/her mail box in order to be able to interrogate the newly received message.

A further problem is that a multiplicity of connection numbers (which is understood here also to include an e-mail address) have to be remembered or stored in order to send messages to a subscriber with a number of communications terminals. On the one hand, this requires a large amount of memory space in address or contact databases. On the other hand, it is simply difficult to remember a large number of call numbers and other contact addresses. If the subscriber has, for example, mobile telephone and fixed line telephone, e-mail address and telefax device with its own connection, a total of three call numbers and one e-mail address are assigned to him/her.

An object of the present invention is, therefore, to propose a method and a device for transmitting messages in an intelligent network with which the problems mentioned at the beginning can be avoided.

### SUMMARY OF THE INVENTION

The core of the present invention is to automatically select the communications terminal in an intelligent network, so that a sender of a message to a subscriber with a multiplicity of communications terminals is relieved of the need to select himself/herself the communications terminal suitable to receive a message. In addition, he/she no longer has to remember as many call numbers of the various connections assigned to the communications terminals. It is generally sufficient for the sender to know one call number assigned to the subscriber and select it for any form of message; text, voice or image. A selection of the receiver's communications terminal which is suitable for the message is then made automatically in the intelligent network.

According to the present invention, this is carried out via a method for transmitting messages in an intelligent network, a multiplicity of different communications terminals being assigned to one subscriber in the intelligent network. When a message for the subscriber is received in a network node of the intelligent network, at least one communications terminal for receiving a message is selected as a function of an accessibility profile of the subscriber and/or of the type of message, and the message is passed on to the at least one selected communications terminal. Passing on is to be understood here in the sense of routing. That is to say, “passing on a message” refers to the transmission of a message from the receiving network node to a terminal of the subscriber. Via the accessibility profile it is possible, for example, for the communication terminal to which the subscriber currently has access to be selected for call reception. The accessibility profile may be, for example, a data record in which the accessibility of a subscriber at various times of day is defined. For example, it is possible to specify in the data record that the subscriber can be accessed on his/her mobile telephone in the morning and on his/her fixed line telephone in the afternoon. In addition, the communications terminal to which the message is sent can be selected by reference to the type of message. The type of message is understood here as text message, image message or voice message. The type of message is determined, in particular, depending on the main content of the message and/or on the terminal provided for reception. Therefore, a telefax message which predominantly contains text is an image message. For example, the telefax device of the subscriber can be selected for a telefax message and/or image message, his/her mobile telephone or fixed line telephone can be selected for a voice message, and his/her mobile telephone can be selected for a text message. A message also can be passed on to a number of selected communications terminals, either simultaneously in the sense of a broadcast or in chronological succession; for example, until a communications device which is ready for reception has been accessed. The method not only makes it easier for a user to send one or more messages but also saves time, as a message generally only has to be sent once. The intelligent network deals, as it were, with the “delivery” without human intervention.

Before being passed on to a communications terminal, the message also can be converted into the type of message which is suitable for processing by the communications terminal. For example, a voice message can be converted into a text message or e-mail message, and vice versa, and/or a telefax can be converted into a text message or e-mail message, and vice versa. It is also possible, for example, for an important text message to be read out to a subscriber over his/her mobile telephone. A corresponding setting is preferably made via the accessibility profile. The value of the method is particularly increased if it is simplified by the allocation of priorities. To do this, a subscriber can configure his/her accessibility profile in such a way that only voice messages and text messages with a predefined priority are passed on to his/her mobile telephone. In this case, the text messages can be read out to the recipient via a text-to-speech device.

At least one flexible service logic preferably processes messages in a service control node of the intelligent network. In particular, the at least one flexible service logic selects communication terminals for reception of the messages, if appropriate converts messages and passes messages on to selected communications terminals. Conversion of the messages is understood here, in particular, to be conversion into a particular protocol which is suitable for sending or transmitting messages.

In one preferred embodiment of the method of the present invention, when a message is received, the service control node starts a flexible service logic which analyzes the message and selects, at least one as a function of the result of the analysis and as a function of predefined parameters, communications terminal for the reception of the message. The predefined parameters may be obtained, for example, from the accessibility profile.

After selection of a communications terminal, the service control node preferably sets up a connection to the selected communications terminal and starts a generic protocol for the transmission of the message to the communications terminal. In such a case, the message can be transmitted by a service data node gateway.

In order to monitor the transmission of the messages, the communications terminal which receives the message preferably generates a confirmation response for confirmation of the reception and sends it to the service data node gateway. After the confirmation response has been received by the service data node gateway, the generic protocol can be terminated. This confirmation response then can be transferred to the flexible service logic and evaluated via at least one program module which is independent of the service.

The present invention also relates to a device for transmitting messages in an intelligent network in which a service control node is designed in such a way that, when a message for a subscriber is received, it selects, as a function of an accessibility profile of the subscriber and/or of the type of message, at least one communications terminal which is suitable for reception of the message, and passes on the message to the at least one selected communications terminal.

A communications gateway is preferably connected to the service control node. Messages are conveyed via the communications gateway.

In one particular preferred embodiment of the device, the communications gateway and service control node communicate via a message interface; in particular, via TCP/IP. In one preferred embodiment they are integrated with one another.

In addition, the communications gateway can be connected to at least one service data node gateway via which messages are transmitted.

The service control node preferably has at least one flexible service logic for processing the messages.

In one particularly preferred embodiment, the service control node includes at least one protocol module for generic messages.

Finally, the communications gateway can have a generic protocol stack for communication with the service control node, and at least one message-specific protocol stack for communication with communications terminals.

Additional features and advantages of the present invention are described in, and will be apparent from, the following Detailed Description of the Invention and the Figures.

### BRIEF DESCRIPTION OF THE FIGURES

FIG. 1 shows the exemplary embodiment of the integration of a communications gateway into an intelligent network.

FIG. 2 shows an exemplary embodiment of a SCP according to the present invention and of a communications gateway.

### DETAILED DESCRIPTION OF THE INVENTION

The abbreviations used below are explained in the appended list containing reference symbols' and abbreviations.

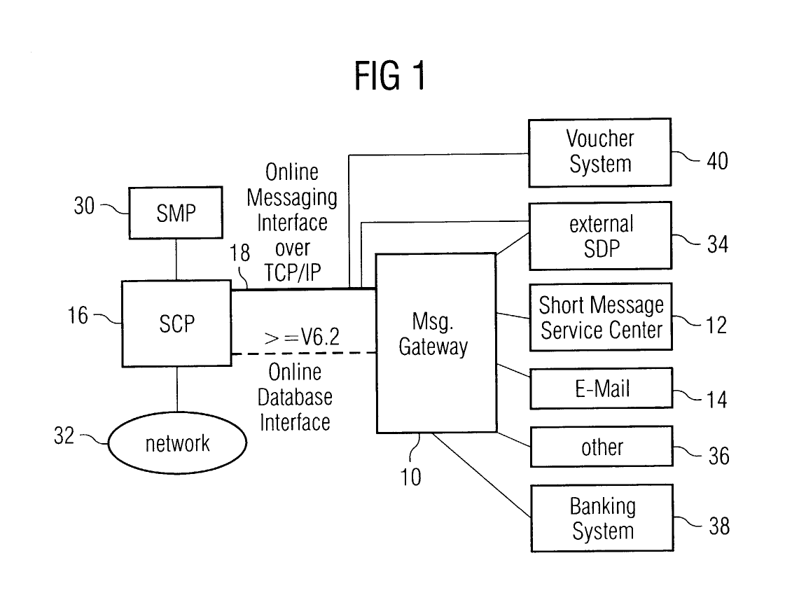

In FIG. 1, a communications gateway 10 (message gateway) is connected to a SCP 16 of an intelligent network via a TCP/IP connection 18. The SCP 16 is connected to a telecommunications network 32; for example, PSTN or ISDN. In addition, an SMP 30 is connected to the SCP 16.

A voucher system 40 and an external STP 34 are connected to the SCP 16 via the TCP/IP connection 18, as well as the communications gateway 10.

The communications gateway 10 can communicate with a short message service center 12 for sending SMS messages, an e-mail client 14 for e-mails or another communications terminal 36; for example, a telefax device.

The entire communication with a subscriber who has a number of communications terminals such as a fixed line telephone and a mobile telephone, a telefax device and an e-mail address and/or e-mail box takes place via the communications network 10. However, it is also possible to access a banking system 38 via the communications gateway 10.

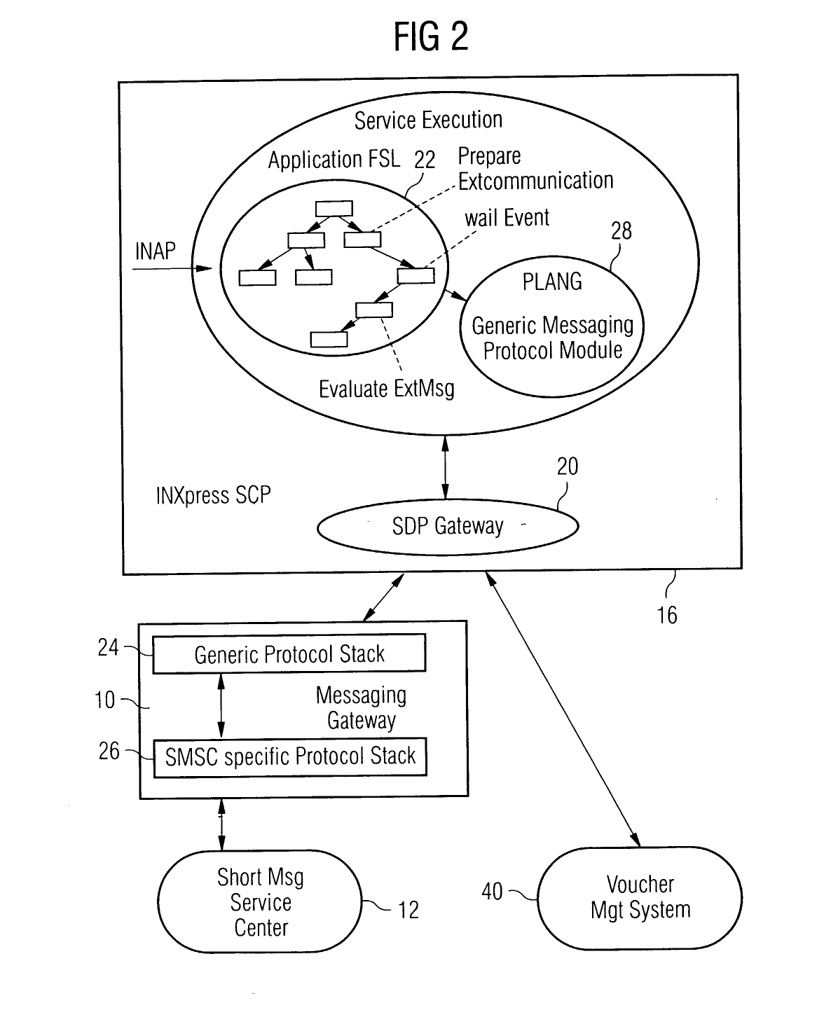

FIG. 2 shows the structure of the SCP 16 and of the communications gateway 10.

The SCP 16 has functions for executing services, including an FSL 22 for processing incoming messages for subscribers. The FSL 22 analyzes incoming messages with respect to their type; that is to say, whether they are a text message, image message or voice message. When the FSL 22 has determined the type of an incoming message, it selects at least one corresponding communications terminal 12 for the reception of the message. In doing so, it also can take into account parameters from an accessibility profile of the subscriber.

A protocol module for generic messages 28 is then used to convert the message into a protocol which is suitable for transmission. The message which is converted in this way is transferred to the communications gateway 10 via an SDP gateway 20.

The communications gateway 10 stores the received message in a generic protocol stack 24. In addition, the communications gateway 10 converts the message into a protocol for the communications terminal 12, in the present case into the protocol used for an SMS message. The message which is converted in this way is then sent to the communications terminal, which is symbolized in the present case by the short message service center 12.

The functionality made possible by the present invention can be implemented, for example, via SIBs in the SCP 16.

Although the present invention has been described with reference to specific embodiments, those of skill in the art will recognize that changes may be made thereto without departing from the spirit and scope of the present invention as set forth in the hereafter appended claims.

1. A method for transmitting messages in an intelligent network in which a plurality of different communications terminals are assigned to a subscriber, the method comprising the steps of:
receiving a message for the subscriber in a network node of the intelligent network;
selecting at least one communications terminal for reception of the message as a function of at least one of an accessibly profile of the subscriber and a type of message; and
passing on the message to the at least one selected communications terminal.

2. A method for transmitting messages in an intelligent network as claimed in claim 1, the method further comprising the step of converting the message, before being passed on to the at least one selected communications terminal, into the type of message which is suitable for processing by the at least one selected communications terminal.

3. A method for transmitting messages in an intelligent network as claimed in claim 2, wherein a voice message is converted into one of a text message and an e-mail message, and vice versa.

4. A method for transmitting messages in an intelligent network as claimed in claim 2, wherein a telefax is converted into one of a text message and an e-mail message, and vice versa.

5. A method for transmitting messages in an intelligent network as claimed in claim 1, the method further comprising the step of processing messages, via at least one flexible service logic, in a service control node of the intelligent network, including selecting communications terminals for reception of the messages and, if appropriate, converting the messages and passing the messages on to the selected communications terminals.

6. A method for transmitting messages in an intelligent network as claimed in claim 5, wherein, when a message is received, the service control node starts the flexible service logic which analyzes the message and selects, as a function of an analysis result and pre-defined parameters, at least one communications terminal for the reception of a message.

7. A method for transmitting messages in an intelligent network as claimed in claim 6, wherein, after the selection of a communications terminal, the service control node sets up a connection to the selected communications terminal and starts a generic protocol for the transmission of the message to the communications terminal.

8. A method for transmitting messages in an intelligent network as claimed in claim 7, wherein a service data node gateway transmits the message.

9. A method for transmitting messages in an intelligent network as claimed in claim 8, wherein the communications terminal receives the message, generates a confirmation response and sends the confirmation response to the service data node gateway.

10. A method for transmitting messages in an intelligent network as claimed in claim 9, wherein the generic protocol is terminated after the confirmation response has been received by the service data node gateway.

11. A method for transmitting messages in an intelligent network as claimed in claim 10, wherein the confirmation response is transferred to the flexible service logic and is evaluated by at least one program module which is independent of the service.

12. A device for transmitting messages in an intelligent network, comprising:
a service control node; and
at least one communications terminal;
wherein, when a message for a subscriber is received, the service control node selects, as a function of an accessibility profile of at least one of the subscriber and the type of message, the at least one communications terminal for reception of the message, and passes on the message to the at least one selected communications terminal.

13. A device for transmitting messages in an intelligent network as claimed in claim 12, further comprising a communications gateway connected to a service control node via which messages are conveyed.

14. A device for transmitting messages in an intelligent network as claimed in claim 13, wherein the communications gateway and the service control node communicate via a TCP/IP message interface.

15. A device for transmitting messages in an intelligent network as claimed in claim 13, wherein the communications gateway is connected to at least one service data node gateway via which messages are transmitted.

16. A device for transmitting messages in an intelligent network as claimed in claim 13, wherein the service control node has at least one flexible service logic for processing messages.

17. A device for transmitting messages in an intelligent network as claimed in claim 13, wherein the service control node includes at least one protocol module for generic messages.

18. A device for transmitting messages in an intelligent network as claimed in claim 13, wherein the communications gateway has a generic protocol stack for communication with the service control node, and at least one message-specific protocol stack for communication with communications terminals.
